(19) United States
(12) Patent Application Publication
(10) Pub. No.: US 2007/0084804 A1
(43) Pub. Date: Apr. 19, 2007

(54) Process for disinfection of sewage sludge

(75) Inventors: Harry E. Buckholtz, Lewiston, NY (US); Ronald A. Richardson, Carson City, NV (US); Victor G. Sanchez, Kingwood, TX (US)

Correspondence Address: Vincent G. LoTempio, PO Box 820, East Amherst, NY, 14051, US

(73) Assignee: Magna Management, Inc.

(21) Appl. No.: 11/581,715

(22) Filed: Oct. 16, 2006

Related U.S. Application Data
(60) Provisional application No. 60/728,136, filed on Oct. 18, 2005.

(51) Int. Cl. C02F 11/00

(52) U.S. Cl. 210/764; 210/209

(57) ABSTRACT

A process for treating sewage sludge with percent solids less than 20 percent comprises (1) contacting sewage sludge that contains undesirable microorganisms with at least one compound that produces methyl isothiocyanate in water to form a reaction mixture, (2) mixing the reaction mixture, and (3) maintaining the reaction mixture in a closed vessel for at least about two hours. After the reaction mixture is maintained in a closed vessel for the desired time, the closed vessel can be vented to the atmosphere for a time sufficient to dissipate residual methyl isothiocyanate from the reaction mixture.

This application claims priority of U.S. Provisional Patent Application of Harry E. Buckholtz, Ronald A. Richardson, and Victor G. Sanchez, Ser. No. 60/728,136 for PROCESS FOR DISINFECTION OF SEWAGE SLUDGE, filed on Oct. 18, 2005.

### BACKGROUND OF THE INVENTION

The treatment of sewage sludge, such as generated during the treatment of wastewater in wastewater treatment facilities, septic tanks, and lagoons poses a large problem in most parts of the world. By definition, sewage sludge is “solid, semi-solid, or liquid residue generated during the treatment of domestic sewage in a treatment works” —U.S. EPA CFR40 Part 503.9(w)]. Such sewage sludge typically contains harmful microorganisms, such as pathogenic bacteria, enteric viruses, and helminth ova. In addition, sewage sludge typically produces unpleasant odors due to bacterial breakdown of fat, protein, and carbohydrate molecules into volatile molecules. Also, sewage sludge often attracts undesirable pests, such as flies and rats, a problem which is referred to as “vector attraction.”

Different types of wastes have different compositions and can present somewhat different challenges. For example, although wastes from an animal feeding operation and sewage sludge both contain fecal matter, the latter are usual much more dilute than the former.

Conventional sewage sludge treatment often involves a step in which water is separated from solids, and a bacterial digestion step to break down some of the organic compounds in the solids. The sewage sludge at the beginning of the treatment process is referred to as “primary sewage sludge,” and after bacterial digestion it is referred to as “digested sewage sludge.”

Primary or digested sewage sludge is difficult to further process economically using traditional sewage sludge treatment methods. The decanted water portion either must be separately treated with a disinfectant such as chlorine, or must return to the head of the wastewater treatment plant for treatment before discharge to the environment Residual organic matter and pathogens in the separated wastewater, when chlorinated, may be partially converted to chlorinated hydrocarbons such as chloroform or carbon tetrachloride.

The partially concentrated sewage sludge solids, after undergoing aerobic or anaerobic digestion by bacteria, are typically further concentrated by dewatering using filter presses or centrifuges, or may be dried naturally on sand drying beds. The concentrated residual sewage sludge may still require further treatment to achieve the necessary pathogen reduction and vector attraction reduction.

Overall, traditional sewage sludge treatment processes are capital intensive, time-consuming, and financially burdensome, especially in areas having low population density. Smaller communities or rural areas often have few resources to practice comprehensive sewage sludge treatment. Under such conditions, long distance hauling of these pathogen-containing and odoriferous wastes to larger wastewater treatment facilities is often necessary to permit the sewage sludge to undergo full treatment and disinfection. Alternatively, untreated sewage sludge may be stored in lagoons, posing potential health threats to the population and/or generating undesirable environmental conditions (e.g., foul odors). For highly populated areas, the hauling of pathogen-containing sewage sludge presents a potential health and quality of life problem, as the sewage sludge is transported away from the populated areas.

An alternative method that has been used to treat digested sewage sludge involves mixing it with a chemical compound that will produce methyl isothiocyanate (MITC). Although this method is beneficial, it has not overcome all existing problems. For example, treating the influent to a wastewater treatment plant with MITC has been considered unattractive in the past because the influent is quite dilute (e.g., 0.2-1.5% solids). Because of the dilute nature of the wastewater, it has been believed that it would be necessary to treat it with MITC for relatively long times in order to achieve adequate reduction of harmful microorganisms. Using a mechanical process to thicken primary sewage, which typically has percent solids of 0.2-1.5%, prior to treatment with MITC would require a relatively large investment in capital equipment. Another potential problem with MITC treatment is that residual MITC in the treated sewage sludge may be phytotoxic, and therefore can prevent germination of seeds. As a result, the application of such treated sewage sludge to an agricultural field could be harmful to the plants grown in the field. In order to avoid this, in the past the sewage sludge has typically also been treated with additional chemicals to deactivate the MITC. However, the use of additional chemicals can lead to other problems, such as elevated sodium content in the sewage sludge, which can harm plants when the sewage sludge is applied to an agricultural field.

There is a need for improved processes for treating sewage sludge that can overcome or minimize one or more of the problems discussed above.

### SUMMARY OF THE INVENTION

One aspect of the invention is a process for treating sewage sludge. The process comprises (1) contacting sewage sludge that contains undesirable microorganisms with at least one compound that produces methyl isothiocyanate in water to form a reaction mixture, (2) mixing the reaction mixture, and (3) maintaining the reaction mixture in a closed vessel for at least about fourteen hours. In most cases, this method can eliminate or render harmless at least about 99% of the undesirable microorganisms in the starting sewage sludge, or in some cases, at least about 99.9%. In one embodiment of the process, an at least three-log reduction (i.e. 99.9%) in the density of enteric virus and at least two-log reduction (i.e. 99%) in the density of viable helminth ova is achieved without adding any compound to increase the pH of the reaction mixture other than the at least one compound that produces methyl isothiocyanate. These magnitudes of reductions are required to conform to U.S. EPA regulations for Class A designation as cited in CFR40, Part 503.)

The length of time during which the reaction mixture is maintained in the closed vessel can vary, but in some embodiments of the process this will extend for about 4-14 hours. In many embodiments of the process, the reaction mixture will be agitated in the closed vessel for some or all of the treatment time. The mixing time can vary, with more dilute sewage sludge often requiring a longer period of mixing.

After the reaction mixture is maintained in the closed vessel for the desired time, the closed vessel can be vented to the atmosphere for a time sufficient to dissipate residual methyl isothiocyanate from the reaction mixture. For example, in some embodiments of the process, the vessel can be vented to the atmosphere for about 14-23 hours. Optionally, a gas can be sparged through the reaction mixture while the closed vessel is vented to the atmosphere, to enhance the removal of any residual methyl isothiocyanate.

The reaction mixture can be recovered from the vessel and applied to land. For example, the mixture can be spread over the surface of land or injected beneath the surface of land. When the treated reaction mixture is applied to the land, it adds organic material to the soil, fertilizes crops grown in the soil, or both.

The process can be used on a variety of different types of wastes as well as sewage sludge. For example, it can be used to treat waste generated during animal feeding operations and other wastes that contain fecal matter and undesirable microorganisms, such as pathogenic bacteria, enteric viruses, and/or helminth ova. In addition, either primary or digested sewage sludge sludge, or both, can be treated in the process. In some embodiments of the present process, the starting sewage sludge comprises about 0.1-19% solids.

The at least one compound that produces methyl isothiocyanate can be, for example, an alkali N-methyl dithiocarbamate, such as 42% sodium N-methyldithiocarbamate in an aqueous solution. Other compounds that produce methyl isothiocyanate are known in the field, and can also be used. In some embodiments of the process, the sewage sludge is contacted with about 3-5 gallons of 42% sodium N-methyldithiocarbamate per dry short ton of sewage sludge.

In one particular embodiment of the process, the sewage sludge comprises about 0.1-12% solids and is contacted with about 5 gallons of 42% sodium N-methyldithiocarbamate per dry short ton of sewage sludge to form the reaction mixture. In this embodiment of the process, the reaction mixture is mixed for at least 15 minutes during which time the reaction mixture is turned-over at least two times in the closed vessel. The reaction mixture then is maintained in a closed vessel for at least about 14 hours, and is agitated to prevent solids settling for substantially the entire time that it is maintained in the closed vessel. In this embodiment, the closed vessel is subsequently vented to the atmosphere for at least about 16 hours. The temperature of the sewage sludge is at least about 60° F. The process is likewise effective at temperatures lower than 60° F. However, in many cases, a greater reaction time period is necessary to complete the disinfection of the sewage sludge. In another particular embodiment of the process, the sewage sludge comprises about 12-15% solids and is contacted with about 5 gallons of 42% sodium N-methyldithiocarbamate per dry short ton of sewage sludge to form the reaction mixture. In this embodiment of the process, the reaction mixture is mixed for at least about 15 minutes in the closed vessel, and is maintained in a closed vessel for at least about 14 hours. The closed vessel is subsequently vented to the atmosphere for at least about 16 hours at a temperature of at least about 60° F.

In yet another particular embodiment of the process, the sewage sludge comprises about 12-15% solids and is contacted with about 5 gallons of 42% sodium N-methyldithiocarbamate per dry short ton of sewage sludge to form the reaction mixture. In this embodiment of the process, the reaction mixture is mixed for at least about 5 minutes using a double augur/paddle-type mechanical mixer in the closed vessel, and is then maintained in a closed vessel for at least about 14 hours. The closed vessel is subsequently vented to the atmosphere for at least about 16 hours. The temperature of the sewage sludge is at least about 60° F.

In another particular embodiment of the process, the sewage sludge comprises about 15-22% solids, the sewage sludge is contacted with about 3 gallons of 42% sodium N-methyldithiocarbamate per dry short ton of sewage sludge to form the reaction mixture, the reaction mixture is mixed for at least about 5 minutes using a double augur/paddle-type mechanical mixer in the closed vessel, and the reaction mixture is maintained in a closed vessel for at least about 14 hours. In this embodiment, the closed vessel is subsequently vented to the atmosphere for at least about 23 hours. The temperature of the sewage sludge is at least about 60° F.

Another aspect of the invention is a transportable system for treating sewage sludge. The system comprises a transportable vehicle, a sealable vessel supported on the transportable vehicle, means for feeding sewage sludge to the sealable vessel, and means for feeding at least one compound that produces methyl isothiocyanate in water to the sealable vessel. The system also comprises means for mixing sewage sludge in the interior of the sealable vessel, means for venting the sealable vessel to the atmosphere, and means for removing treated sewage sludge from the sealable vessel and transferring it to an external site. The system also may comprise means for agitating the sewage sludge in the interior of the sealable vessel after it is mixed. The transportable vehicle can be, for example, a truck trailer or a rail car. In some embodiments, the transportable system also includes means for sparging a gas through sewage sludge in the interior of the sealable vessel while the vessel is vented to the atmosphere. The means for mixing sewage sludge in the interior of the sealable vessel optionally can be portable and removable from the system.

### BRIEF DESCRIPTION OF THE DRAWINGS

FIG. 1 is a process flow diagram of a sewage sludge treatment process in accordance with the present invention.

FIG. 2 is a schematic diagram of a transportable sewage sludge treatment system in accordance with the present invention.

### DESCRIPTION OF SPECIFIC EMBODIMENTS

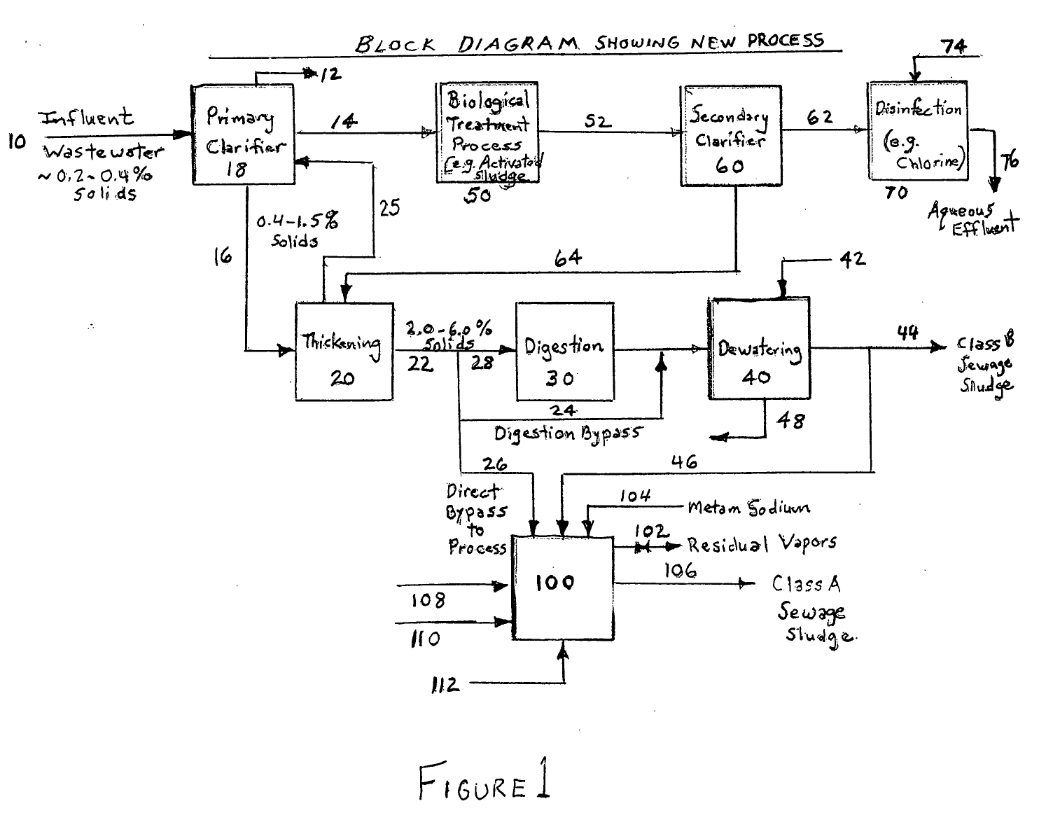

One embodiment of the present invention is shown in FIG. 1. A conventional process for treating wastewater (i.e., either domestic sewage or domestic sewage commingled with other wastewater) includes the steps of clarifying the influent wastewater to separate solids from water, treating the clarified wastewater in a biological process, clarifying the wastewater after biological treatment, and treatment with chlorine/dechlorination of the wastewater prior to releasing it to the environment. Sewage sludge generated during the clarification processes can be digested to reduce the bacterial content of the sewage sludge and then dewatered to produce a cake. The present invention allows this process to be modified by the inclusion of an additional sewage sludge treatment step which, in some embodiments of the process, can make the digestion step and/or some other steps unnecessary.

In FIG. 1, the influent wastewater 10 has large non-sewage items such as stones and rags removed in a grit chamber (not shown), and then is fed into a primary clarifier 18. The influent wastewater tends to be relatively dilute, for example having a solids content of about 0.2-0.4%. (All composition percentages in this patent are by weight unless otherwise stated.) Although the embodiment of FIG. 1 is described herein with respect to relatively dilute sewage sludge, it should be understood that the process can be used with sewage sludge with higher percent solids. For example, in some embodiments of the invention, the sewage sludge has a solids concentration of 0.1-13%, or in some cases >13%. skimmed off for separate disposal or can be incorporated into the closed reactor 10

In the clarifier, the wastewater is allowed to stand, so that the solids 16 therein settle to the bottom, and the fats 12 therein float to the surface. The fats can then be 0 for treatment along with the sewage sludge to be treated with a salt or acid of N-methyl dithiocarbamate. Fats are nutritious to the soil, and break down slowly under the action of soil bacteria, and thus can be a useful addition to soil chemistry.

Wastewater 14 from the clarifier is then passed into a biological treatment vessel 50, which is an activated sludge unit or the like. The effluent 52 from this unit flows to a secondary clarifier 60, where solids are permitted to settle. Aqueous effluent 62 is directed to a disinfection step 70, where it is contacted with chlorine 74 or some other oxidizer 74 before being discharged to the a dechlorination step (not shown). The aqueous effluent 76 after undergoing dechlorination is discharged into the environment.

A solids stream 16, which can still be relatively dilute (e.g., 0.4-1.5% solids) is removed from the clarifier 18 and is fed to a thickener 20. Solids from the secondary clarifier 60 are likewise directed to the thickener 20, where the solids percentage is increased. Liquid 25 from the thickener is sent to the primary clarifier 18. The solids content of the thickened sewage sludge 22 is increased to ˜2%-6%. This stream can be directed in several ways. In a conventional wastewater treatment facility, the thickened solids are sent to a digester 30 via stream 28 shown in FIG. 1. In the digester 30, the solids are exposed to bacteria which can digest some or all of the compounds present. After a period of bacterial digestion (for example, for 10-30 days), the digested solids are then dewatered, for example through a belt filter press 40. Optionally, a coagulant 42 can be added to the material to make the dewatering operation more efficient. The dewatering operation produces a water stream 48, which can be returned to the head of the plant for treatment where it is treated in the primary clarifier. The clarified water then is treated in the remaining unit processes before discharge to the environment. A cake 44, which can contain about 18-30% solids, is sufficiently treated to be land-applied as Class B sewage sludge or may be placed in a landfill or incinerated. This cake 44 can pose health and odor problems due to the continued presence of viable bacteria and other pathogenic entities. Without additional treatment, this cake can be Class B with respect to pathogens under current U.S. EPA regulations, which limits the sites to which it can be land-applied. However, in the embodiment of the invention shown in FIG. 1, this problem is prevented or mitigated by in the inclusion of a methyl isothiocyanate treatment step, which is depicted in FIG. 1 as vessel 100.

In FIG. 1, instead of passing the primary sewage sludge from the clarifier 18 to the thickener 20, the primary sewage sludge 16 may be directed into the closed treatment vessel 100. Alternatively, the sewage sludge can be thickened to a greater percentage (e.g., 2-6% solids) via the thickener 20, and the solids effluent from the thickener passed directly to the closed treatment vessel 100 as stream 26. It is also possible to re-direct the thickener solids stream 24, bypassing the digester 30 and feeding stream 24 directly to the dewatering unit process 40. Sewage sludge from the dewatering unit, which may contain 12%-30% solids, can likewise be directed to the closed treatment vessel 100, via stream 46. In vessel 100, the sewage sludge is contacted with at least one compound that produces methyl isothiocyanate (MITC) when exposed to water, stream 104. A variety of compounds that will generate MITC when contacted with water are known in the field, such as methyldithiocarbamic acid and several of its salts. Any one or more of these compounds can be used in the process. One suitable compound is sodium N-methyldithiocarbamate, which is commonly referred to as metam-sodium and is commercially available at a 42% concentration in an aqueous solution.

The sewage sludge is mixed for a time in the closed vessel after addition of the MITC-producing compound to promote mixing of the MITC with the solids, and particularly with the microorganisms in the sewage sludge. Although the mixing could also take place prior to closing the vessel, it is more desirable to perform the mixing while the vessel is sealed. If the sewage sludge contains no more than about 13% solids, the mixing can preferably be done using a conventional mechanical mixing system, such as an agitator, turbine, high circulation pump, or the like, that permits substantially homogeneous suspension of solids and intimate mixing of treating agent and sewage sludge. If the sewage sludge has a solids concentration greater than about 10%, the mixing can be done utilizing a double augur/paddle type mechanical mixer.

The vessel 100 can be left in a closed state for a time sufficient to allow the desired elimination of helminth ova, bacteria, viruses, and the like. After the necessary time has elapsed, the vessel 100 can be vented to the atmosphere by means of a valve 102 or the like. This allows any residual MITC present to dissipate into the atmosphere or to be scrubbed through an adsorbent (e.g., activated carbon) or acid (e.g., dilute sulfuric acid). Optionally, a stream 112 of air or an insert gas can be sparged into the vessel to aid in purging the residual MITC. The treated sewage sludge 106, which will contain greatly reduced concentrations of harmful microorganisms, and in some cases no detectable amount of such microorganisms at all, and will generally produce less odor problems, can then be land-applied as a Class A sewage sludge. In some embodiments of the process, one or more of the other steps, such as bacterial digestion and dewatering, can be eliminated.

In some embodiments of the process, the temperature in the vessel 100 is generally about 50-120° F. during the treatment, or in most cases, about 60-90° F.

Although FIG. 1 shows how the MITC treatment can be used near the beginning of the sewage sludge treatment process, it should be understood that the MITC treatment could alternatively occur at other points in the process. For example, instead of treating primary sewage sludge, the MITC treatment could be performed on the cake 46 from the dewatering unit 40 (i.e., the MITC treatment could be performed on digested sewage sludge rather than on primary sewage sludge). This is one of many possible options for the incorporation of the MITC treatment in a sewage sludge treatment system.

It should be understood that although FIG. 1 shows a primary and secondary clarifier, (18 and 60) one thickener 20, one digester 30, one dewatering unit 40, and one closed vessel 100, there could be more than one of any of these devices used. Such variations in the process are well known in the field.

Although it is often not required, the process of the present invention can optionally also include the step of adding an alkali (stream 108) to the sewage sludge to raise its pH to >12 to meet vector attraction reduction requirements under certain circumstances. This pH adjustment can be useful in some instances to enhance elimination of viruses, although generally such viruses are reduced to non-detectable levels by the MITC treatment. Suitable chemical agents for increasing the pH are well known, such as caustic soda. For example, the material can be kept at a pH >12 for at least about two hours and at a pH >11.5 for at least about an additional 22 hours, before optionally being pH adjusted with an acidic compound (stream 110) to a more neutral (e.g., 5.5 to ˜8.0) condition before land application, or directly land applied at the higher pH without adjustment.

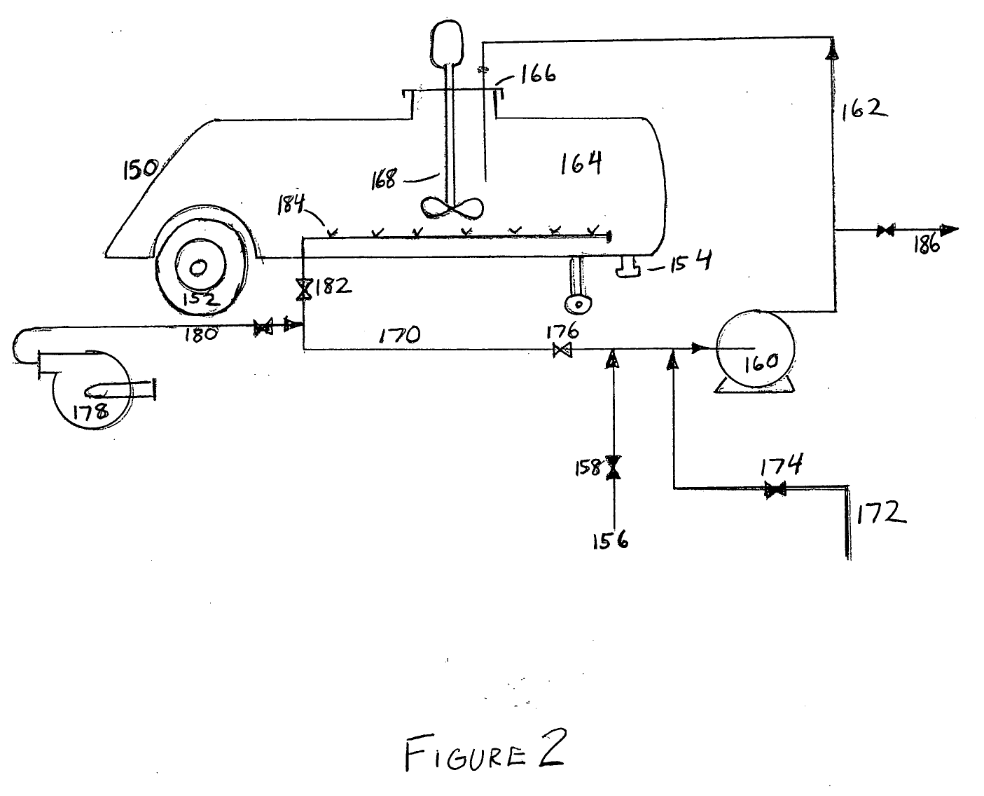

The process of the present invention can be performed at a conventional wastewater treatment plant site, or it can be performed on a transportable vehicle, such as a truck trailer or a rail car, which offers certain advantages in some situations. FIG. 2 shows one transportable embodiment of the invention. The equipment shown in this figure is mounted on a truck trailer 150 which is mounted on wheels 152 and includes apparatus 154 for attaching it to a truck tractor. Sewage sludge 156 is fed into the system by opening a valve 158. A charge and circulation pump 160, which could be fixed in a single location or could be mounted on the trailer, pumps the sewage sludge through a fill and circulation line 162 into a sealable tank 164 which is mounted on the trailer 150. After the appropriate amount of sewage sludge, generally a minimum of ⅔ of the volume of the tank, has been added to the tank 164, the valve 158 is closed. The compound that generates MITC can be added to the sewage sludge, for example by being manually added to the tank 164 through a top hatch 166 that can then be closed to seal the tank. Alternatively, the compound could be added through the suction line of the circulation pump 160. The contents of the tank are mixed by means of a portable agitator or mixer device 168. Optionally, the sewage sludge can be mixed by pumping it through a recirculation line 170 and back through the line 162 into the tank 164.

If it is desired to also include a step in the process in which the pH of the sewage sludge is increased, then an alkali material, such as caustic soda, can be added through an alkali fill line 172 by opening a valve 174.

After the desired treatment time has passed, the top hatch 166 can be opened to allow residual MITC to dissipate into the atmosphere. This dissipation can be enhanced by closing the valve 176 and sparging air, carbon dioxide, or an inert gas such as nitrogen into the tank by means of a blower 178 and line 180. The sparge gas passes through an open valve 182 and through sparging apparatus 184 into the contents of the tank 164.

After the residual MITC has been dissipated, the treated sewage sludge can be discharged through a line 186, using pump 160. Land application may be easily carried out with typical liquid injection or slurry pumping equipment, or land spreading equipment, completing the process.

Although the above description and figures outline certain embodiments of the invention, there are numerous other possible variations.

One embodiment of the invention is a process for rapid conversion of primary or digested sewage sludge, which may potentially contain pathogenic bacteria, viable helminth ova, and enteric virus, into a non-pathogenic material with reduced odor. The resulting treated sewage sludge can readily be land applied as a soil conditioner and a source of carbon, nitrogen and other nutrients beneficial to soil bacteria and plant life. The process comprises homogeneous mixing of the subject sewage sludge with salts of N-methyldithiocarbamate, or methyldithiocarbamic acid, in a closed batch reactor. The N-methyldithiocarbamate forms a vapor, methyl isothiocyanate (MITC), in the presence of diluent water and organic matter, which is the active entity in the disinfection process. Sewage sludge with a solids concentration of 0.1% to 12% may be mixed in a closed vessel employing conventional pump circulation or mixing equipment. Sewage sludge with a solids concentration >10%, however, is best mixed in a closed double auger/paddle type mixer. Following the treatment time, the closed vessel may be exposed to the air to dissipate residual MITC to render the sewage sludge non-phytotoxic. The disinfected biosolids can then be directly land applied as a nutritious source of carbon, nitrogen, phosphorus, potassium and other trace minerals beneficial to the soil and plant growth.

In the process of the present invention, it is generally not necessary to add inert solids to the sewage sludge as a shearing or bulking agent to promote homogeneous exposure of sewage sludge to MITC, or to add a hydrophilic polymer. However, one or more of these materials optionally can be added if desired.

Likewise, it is generally not necessary to add an alkali material to raise the pH of the sewage sludge above its existing level after MITC treatment. Adequate pathogen reduction usually takes place at the pH imparted to the sewage sludge by the MITC alone, which is typically about a pH of 8.6 to 9.2. It is also not necessary to add a neutralizing agent to de-activate the MITC in the sewage sludge. Upstream thickening of the sewage sludge (solids concentration by solid/liquid separation technology) is also not necessary.

Various embodiments of the process described herein can reduce the maximum time required to render the resulting sewage sludge non-phytotoxic in 16 hours at 50° F. for treated sewage sludge having from 0.1% to 13% solids concentration, and in 16-32 hours at 50° F. for treated sewage sludge having >13% solids concentration. At temperatures exceeding 50° F., the atmospheric exposure time needed to render the sewage sludge non-phytotoxic is generally less than these maximum times.

At least some embodiments of the invention provide a process for treating primary or digested sewage sludge sludge, to permit safe, widespread, sustainable, and economical land application, both to condition the soil and to fertilize crops grown in the soil. The avoidance of the spread of pathogens, reduction in generation of greenhouse gases, and reduction of non-point source nitrogen and phosphorus runoff conditions is inherent in this embodiment of the invention. Thus, primary or digested sewage sludge can be converted to an end product that contains non-detectable levels of pathogens, reduced odors, and reduced vector attraction, and which is generally acceptable under environmental regulations (for example, U.S. Environmental Protection Agency regulations found in 40 CFR Part 503) to be land-applied without restriction with respect to pathogens.

Certain embodiments of the invention provide an economically attractive, practical process for treatment of sewage sludge to cause the reduction of pathogenic bacteria, enteric viruses and viable helminth ova to non-detectable levels in one comprehensive step, within a single closed container. In such embodiment, the entire process can be carried out quickly, in 36 hours or less, such that both pathogen reduction and non-phytotoxicity are achieved within that time period. The process can be carried out within a practical range of temperatures to permit successful employment of the process in a wide range of geographical locations. Furthermore, the process can be carried out without the need for alkali addition or neutralization of alkali through post-treatment. The process can be used under low solids concentration conditions in conventional rolling stock, such as tank trailers or tank cars, thus allowing the process to be brought to and employed at remote wastewater treatment facilities. Hauling and application of the disinfected product to land are also expedited.

Certain embodiments of the invention produce a sewage sludge that has non-detectable pathogen content and reduced odor, and is non-phytotoxic, so that it can be safely handled, transported and applied to the land without further treatment. Optionally, the sewage sludge can have its pH raised to 12 or higher for two hours and remain at >11.5 for an additional 22 hours if specified options for vector attraction reduction (such as those specified by U.S. Environmental Protection Agency regulations 40 CFR Part 503) are not practical to employ at a given site. The treated sewage sludge may be land-applied with conventional application equipment well known to the art. The sewage sludge is highly nutritious to the soil and to soil bacteria, adding organic carbon, organic nitrogen and phosphorus in forms that do not contribute to water table pollution. The sewage sludge is non-phytotoxic to plant growth.

The following examples further illustrate specific embodiments:

### EXAMPLE 1

Table 1 summarizes the conditions and results of tests in which samples of primary sewage sludge and digested sewage sludge were spiked with viable helminth ova at an approximate dose of greater than 300-400 ova per 4 grams of dry solids. The spiked sewage sludge samples were then treated with metam sodium at a rate of either 3 or 5 gallons per dry short ton of sewage sludge. Treatment was usually carried out in 15 ml cylindrical plastic screw-capped tubes to insure that the containers were closed. Mixing was effected using a magnetic stirring bar where the sample density permitted, and with a VirTis homogenizer for thicker samples. Larger volume samples were tested in closed beakers or flasks equipped with an electrically or pneumatically driven agitator. Sewage sludge temperature was normally 50°-70° F. during treatment. The treatment time listed in Table 1 represents the period of time during which the sample was kept sealed in the tube after addition of metam sodium to the sewage sludge sample, and after mixing the metam sodium and sewage sludge, prior to the opening of the tube for examination. The mixing time listed in the table is the period during which the metam sodium and the sewage sludge were mixed. After the tubes were opened, the number of viable helminth ova remaining was determined by visual examination of each sample with a microscope.

TABLE 1

| | | | | | | Viable ova | % ova |
|---|---|---|---|---|---|---|---|
| Sewage | | Metam | Mixing | | | (after | viable |
| Sludge | % solids in | sodium | Period | Treatment | | spiking, | (post- |
| type | sludge | dose¹ | (minutes) | time (hrs) | Temp. (° F.) | pre-treat.) | treat.) |
| primary | 2.0 | 5.0 | 15 | 14 | 60 | >300-400 | 0.0 |
| primary | 4.5 | 5.0 | 15 | 14 | 60 | >300-400 | 0.0 |
| primary | 8.0 | 5.0 | 15 | 12 | 60 | >300-400 | 1.0 |
| primary | 4.0 | 5.0 | 15 | 16 | 60 | >300-400 | 1.0 |
| digested | 16.5 | 3.0 | 5 | 4 | 70 | >300-400 | 0.0 |
| digested | 19.9 | 3.0 | 5 | 4 | 70 | >300-400 | 0.0 |
| primary | 30.0 | 3.0 | 5 | 4 | 50 | >300-400 | 0.3 |
| digested | 2.0 | 5.0 | 5 | 12 | 50 | >300-400 | 0.0 |
| digested | 30.0 | 3.0 | 5 | 12 | 50 | >300-400 | 0.5 |
| primary | 8.0 | 2.5 | 15 | 14 | 60 | >300-400 | 0.0 |
| digested | 22.0 | 1.5 | 5 | 14 | 60 | >300-400 | 0.0 |
| primary | 15.0 | 1.5 | 5 | 14 | 60 | >300-400 | 0.0 |

untreated uterine egg control 96.7% viable.
¹Gallons per short ton of sewage sludge (dry weight basis)

### EXAMPLE 2

Table 2 summarizes the conditions and results of tests utilizing samples of primary sewage sludge and digested sewage sludge that were spiked with poliovirus at an approximate density of 1.22×10⁵ plaque-forming units (pfu) per 4 grams of dry solids. The samples were mixed with doses of metam sodium at the equivalent gallons per ton of sewage sludge (dry weight basis) as listed in the table below and after mixing remained in a closed container for the number of hours shown in the table. The density of enteric virus after treatment was determined by analyzing a sample of the treated sewage sludge using a required analytical method (i.e. ASTM D4994-89).

The results are as follows:

TABLE 2

| | | | | | | Enteric virus |
|---|---|---|---|---|---|---|
| | | Metam | Mixing | | | density |
| Sewage | | sodium | Period | Treatment | | (after |
| Sludge type | % solids | Dose¹ | (minutes) | time (hrs) | Temp. (° F.) | treatment) |
| Primary | 2 | 5 | 15 | 4 | 50 | <1 pfu/4 g |
| Primary | 8 | 5 | 15 | 4 | 70 | <1 pfu/4 g |
| Primary | 15 | 3 | 5 | 4 | 70 | <1 pfu/4 g |
| Primary | 30 | 3 | 5 | 4 | 70 | <1 pfu/4 g |
| Digested | 2 | 5 | 15 | 4 | 70 | <1 pfu/4 g |
| Digested | 8 | 5 | 15 | 4 | 70 | <1 pfu/4 g |
| Digested | 15 | 3 | 5 | 4 | 70 | <1 pfu/4 g |
| Digested | 30 | 3 | 5 | 4 | 70 | <1 pfu/4 g |

¹Gallon per short ton of sewage sludge (dry weight basis)

### EXAMPLE 3

Salmonella sp. bacteria were spiked into samples of primary and digested sewage sludge. The density of the Salmonella typhimurium spiking suspension was 1.2×10⁷ cfu/gram. Samples were treated with metam sodium in the same fashion as in the previous examples, with the following results obtained:

TABLE 3

| | | | | | | Salmonella |
|---|---|---|---|---|---|---|
| | | | | | | sp. density |
| | | Metam | Mixing | | | (after |
| Sewage | | sodium | Period | Treatment | | treatment; |
| Sludge type | % solids | dose¹ | (minutes) | time (hrs) | Temp. (° F.) | dry basis) |
| primary | 8 | 5 | 15 | 4 | 70 | <3 MPN/4 g |
| primary | 15 | 3 | 5 | 4 | 70 | <3 MPN/4 g |
| primary | 30 | 3 | 5 | 4 | 70 | <3 MPN/4 g |
| digested | 8 | 5 | 15 | 4 | 70 | <3 MPN/4 g |
| digested | 15 | 3 | 5 | 4 | 70 | <3 MPN/4 g |
| digested | 2 | 5 | 15 | 4 | 60 | <3 MPN/4 g |
| primary | 2 | 5 | 15 | 4 | 60 | <3 MPN/4 g |

¹Gallons per short ton of sewage sludge (dry weight basis)

“MPN” refers to most probable number. The MPN technique is based on a statistical analysis of the number of positive and negative results obtained when testing multiple portions of equal volumes (i.e. multiple samples). The MPN is not an absolute concentration, but only a statistical estimate of the density of microorganisms present.

### EXAMPLE 4

Seven thousand (7,000) gallons of digested sewage sludge sludge, containing 4.6% solids, were circulated in a closed reactor for two complete turnovers of the reactor contents after raising the pH from an initial value of 6.86 to >12 by adding 45% potassium hydroxide. pH was used as the measuring scale for uniformity of the reactor contents, and was measured each minute over a time period of 12 minutes (closely approximating 2 full turnovers of the reactor contents) starting after alkali addition to raise the pH. A statistical analysis of the pH values obtained over the 14-minute mixing period demonstrated at a 90% confidence limit that the pH values obtained approximated a normal distribution. It was concluded that mixing in the tank was uniform.

### EXAMPLE 5

Eighteen thousand (18,000) pounds of belt-filtered sewage sludge containing 16 percent solids were treated with 50% sodium hydroxide (caustic soda) to raise the pH from 6.8 to >12, with a mixing time of 5 minutes in a double auger/paddle type mixer with a paddle operating speed of three revolutions per minute (rpm). After the mixing period, a sampling grid was established. Three pH measurements were taken for each of thirty-two grids at each of three depths: surface, 2-feet and 4-feet. A statistical analysis z-test two samples for means was performed that compared the mean surface pH with the pH measured at 2-feet, and the mean 2-foot depth pH with the mean 4-foot depth pH. It was determined with 95% confidence level that the pH means at the three levels were statistically the same. It was concluded that there was no mean difference of pH at the three different depths, and therefore mixing was homogeneous.

### EXAMPLE 6

Phytotoxicity tests to determine the time/temperature relationship required to dissipate residual vapors of MITC, the active agent in the treatment process, were carried out employing the lettuce seed germination test. In this test, sewage sludge that had been treated with metam sodium was exposed to the atmosphere without circulation of either the treated batch, or forced air circulation over or into the sample, at a given temperature and for a given period of time. The treated sewage sludge sample was mixed with potting soil and water was added to the mixture. Glass wool and filter paper were placed over the treated sewage sludge and 10-20 lettuce seeds were placed on top of the filter paper. The treatment vessel was then sealed and placed in light for three days. The number of lettuce seeds that germinated in three days was then used to determine whether MITC dissipated during the atmospheric exposure time. The following results were obtained:

TABLE 4

| | | Metam | Temperature | Air | |
|---|---|---|---|---|---|
| Sewage | % | sodium | of sewage | exposure | % of seeds |
| sludge type | solids | dose¹ | sludge (° F.) | time (hrs.) | germinated |
| primary | 2 | 5 | 50 | 16 | 100 |
| primary | 4 | 5 | 50 | 16 | 100 |
| primary | 8 | 5 | 50 | 16 | 100 |
| primary | 12 | 5 | 50 | 16 | 100 |
| primary | 15 | 3 | 50 | 16 | 100 |
| primary | 22 | 3 | 50 | 23 | 100 |
| primary | 30 | 3 | 50 | 32 | 100 |
| digested | 2 | 5 | 50 | 16 | 100 |
| digested | 4 | 5 | 50 | 16 | 100 |
| digested | 8 | 5 | 50 | 16 | 100 |
| digested | 12 | 5 | 50 | 16 | 100 |
| digested | 15 | 3 | 50 | 16 | 100 |
| digested | 22 | 3 | 50 | 23 | 100 |
| digested | 30 | 3 | 50 | 32 | 100 |

¹Gallons per short ton of sewage sludge (dry weight basis)

From the tests shown above, it was concluded that residual vapors dissipate at a maximum of 32 hours when the temperature of the sewage sludge is 500F. Time needed for MITC to dissipate will decrease as the temperature of the sewage sludge increases.

The preceding description shows certain specific embodiments of the invention. It is not intended as an exhaustive listing of every possible embodiment. Persons skilled in the field will recognize that other variations and embodiments exist that are within the scope of the following claims.

1. A process for treating sewage sludge, comprising:
a. contacting sewage sludge that contains undesirable microorganisms with at least one compound that produces methyl isothiocyanate in water to form a reaction mixture;
b. optionally incorporating fats skimmed from the surface of the primary clarifier into the sewage sludge;
c. mixing the reaction mixture; and
d. maintaining the reaction mixture in a closed vessel for at least about two hours.

2. The process of claim 1, wherein the reaction mixture is maintained in a closed vessel for about 4-14 hours.

3. The process of claim 1, further comprising subsequently venting the closed vessel to the atmosphere for a time sufficient to dissipate residual methyl isothiocyanate from the reaction mixture.

4. The process of claim 3, wherein the vessel is vented to the atmosphere for about 14-32 hours.

5. The process of claim 3, further comprising sparging a gas through the reaction mixture while the vessel is vented to the atmosphere.

6. The process of claim 3, further comprising recovering the reaction mixture from the vessel and applying the mixture to land.

7. The process of claim 1, wherein the sewage sludge comprises about 0.1-19% solids.

8. The process of claim 1, wherein the at least one compound that produces methyl isothiocyanate is an alkali N-methyl dithiocarbamate.

9. The process of claim 8, wherein the at least one compound that produces methyl isothiocyanate is 42% sodium N-methyldithiocarbamate.

10. The process of claim 9, wherein the sewage sludge is contacted with about 3-5 gallons of 42% sodium N-methyldithiocarbamate per dry short ton of sewage sludge.

11. The process of claim 9, wherein the sewage sludge comprises about 0.1-5% solids, the sewage sludge is mixed at >600F with about 5 gallons of 42% sodium N-methyldithiocarbamate per dry short ton of sewage sludge for 15 minutes to form the reaction mixture, the reaction mixture is maintained in a closed vessel for at least about 14 hours, the reaction mixture is agitated for substantially the entire time that it is maintained in a closed vessel, and the closed vessel is subsequently vented to the atmosphere for at least about 16 hours when the temperature of the reaction mixture is at least about 50° F.

12. The process of claim 9, wherein the sewage sludge comprises about 5-13% solids, the sewage sludge is contacted with about 5 gallons of 42% sodium N-methyldithiocarbamate per dry short ton of sewage sludge to form the reaction mixture, the reaction mixture is mixed at >600F for at least about 15 minutes in a closed vessel, the reaction mixture is maintained in a closed vessel for at least about 14 hours, and the closed vessel is subsequently vented to the atmosphere for at least about 16 hours when the temperature of the reaction mixture is at least about 50° F.

13. The process of claim 9, wherein the sewage sludge comprises about 12-15% solids, the sewage sludge is contacted with about 5 gallons of 42% sodium N-methyldithiocarbamate per dry short ton of sewage sludge to form the reaction mixture, the reaction mixture is mixed at >600F for at least about 5 minutes using a double augur/paddle-type mechanical mixer in the closed vessel, the reaction mixture is maintained in a closed vessel for at least about 14 hours, and the closed vessel is subsequently vented to the atmosphere for at least about 16 hours when the temperature of the reaction mixture is at least about 50° F.

14. The process of claim 9, wherein the sewage sludge comprises about >15% solids, the sewage sludge is contacted with about 3 gallons of 42% sodium N-methyldithiocarbamate per dry short ton of sewage sludge to form the reaction mixture, the reaction mixture is mixed at >600F for at least about 5 minutes using a double augur/paddle-type mechanical mixer in the closed vessel, the reaction mixture is maintained in a closed vessel for at least about 14 hours, and the closed vessel is subsequently vented to the atmosphere for at least about 23 hours when temperature of the reaction mixture is at least about 50° F.

15. The process of claim 1, wherein an at least three-log reduction is achieved in the enteric virus density of the sewage sludge and at least a two-log reduction is achieved in the viable helminth ova density of the sewage sludge without adding any compound to increase the pH of the reaction mixture other than the at least one compound that produces methyl isothiocyanate.

16. A transportable system for treating sewage sludge, comprising:
a. a transportable vehicle;
b. a sealable vessel supported on the transportable vehicle;
c. means for feeding sewage sludge to the sealable vessel;
d. means for feeding at least one compound that produces methyl isothiocyanate in water to the sealable vessel;
e. means for mixing sewage sludge in the interior of the sealable vessel;
f. means for agitating the sewage sludge in the interior of the sealable vessel during the time the sewage sludge remains in the sealable vessel after the mixing period when the percent solids of the sewage sludge is <12 percent;
g. means for venting the sealable vessel to the atmosphere; and
h. means for removing treated sewage sludge from the sealable vessel and transferring it to an external site.

17. The transportable system of claim 16, further comprising means for sparging a gas through the sewage sludge in the interior of the sealable vessel while the vessel is vented to the atmosphere.

18. The transportable system of claim 16, wherein the transportable vehicle is a truck trailer.

19. The transportable system of claim 16, wherein the transportable vehicle is a rail car.

20. The transportable system of claim 16, wherein the means for mixing sewage sludge in the interior of the sealable vessel are portable and can be removed from the system.
